(19) United States
(12) Patent Application Publication
(10) Pub. No.: US 2022/0014223 A1
(43) Pub. Date: Jan. 13, 2022

(54) Smart Phone Holder Assembly

(71) Applicant: Jeanette Hall-Henderson, Bolingbrook, IL (US)

(72) Inventor: Jeanette Hall-Henderson, Bolingbrook, IL (US)

(21) Appl. No.: 16/924,362

(22) Filed: Jul. 9, 2020

(51) Int. Cl. H04B 1/3888; H04R 1/02; G06F 3/16; H04R 3/00

(52) U.S. Cl. CPC H04B 1/3888; H04R 1/028; H04R 2430/01; H04R 3/00; G06F 3/165

(57) ABSTRACT

A smart phone holder assembly includes a base that is positionable on a horizontal support surface. A speaker is coupled to the base to emit audible sound outwardly therefrom. An arm is coupled to and extends upwardly from the base. The arm is comprised of a bendable material such that the arm stays in whatever orientation the arm is manipulated into. A mounting unit is coupled to the arm and the mounting unit releasably engages a smart phone to support the smart phone at a selected orientation. The mounting unit has a plurality of ports is integrated therein and the ports place the smart phone in electrical communication with the speaker and the power supply.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to holder devices and more particularly pertains to a new holder device for holding a smart phone at a desired orientation.

### (2) Description of Related Art Including Information Disclosed Under 37 CFR 1.97 and 1.98

The prior art relates to holder devices including a speaker tube that engages a smart phone to support the smart phone in a vertical orientation. The prior art discloses a bracket that engages a smart phone for standing the smart phone on a support surface. The prior art discloses a housing with a smart phone slot for standing a smart phone therein and which has speakers integrated into the housing for emitting audible sound received from the smart phone. The prior art discloses a bendable arm that is mountable to a railing in a bathroom and which includes a smart phone mount for holding a smart phone. The prior art discloses a base and a sleeve to insertably receive a smart phone in a vertical orientation. The prior art discloses a bendable arm that is can be coiled into a circular base and which has a smart phone mount for holding a smart phone.

### BRIEF SUMMARY OF THE INVENTION

An embodiment of the disclosure meets the needs presented above by generally comprising a base that is positionable on a horizontal support surface. A speaker is coupled to the base to emit audible sound outwardly therefrom. An arm is coupled to and extends upwardly from the base. The arm is comprised of a bendable material such that the arm stays in whatever orientation the arm is manipulated into. A mounting unit is coupled to the arm and the mounting unit releasably engages a smart phone to support the smart phone at a selected orientation. The mounting unit has a plurality of ports is integrated therein and the ports place the smart phone in electrical communication with the speaker and the power supply.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a smart phone holder assembly according to an embodiment of the disclosure.

FIG. 2 is a back perspective view of an embodiment of the disclosure.

FIG. 3 is an exploded perspective view of an embodiment of the disclosure.

FIG. 4 is a perspective in-use view of an embodiment of the disclosure.

### DETAILED DESCRIPTION OF THE INVENTION

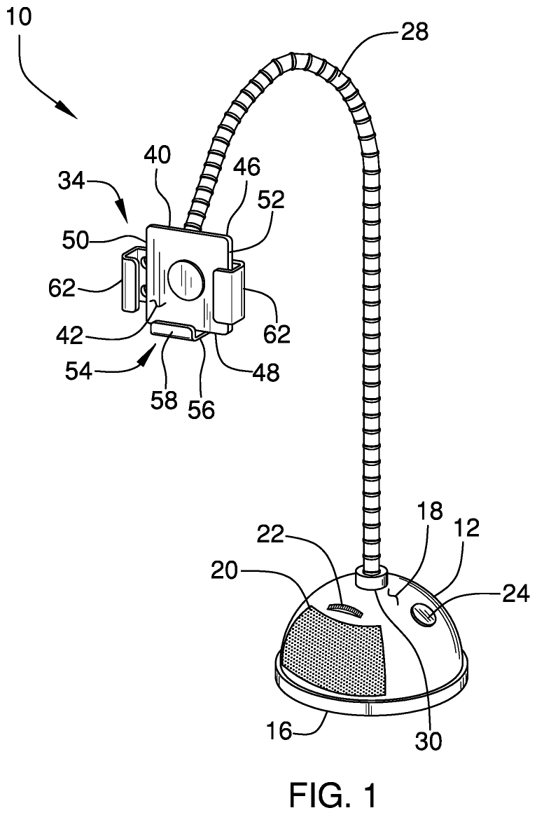

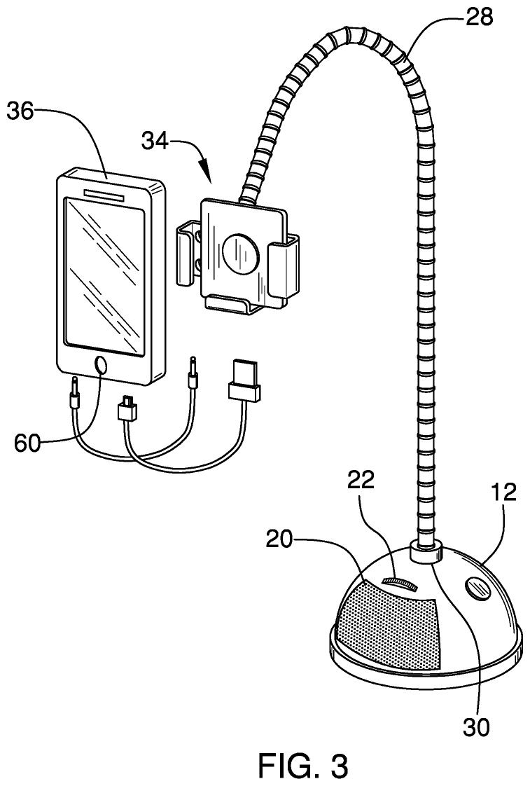

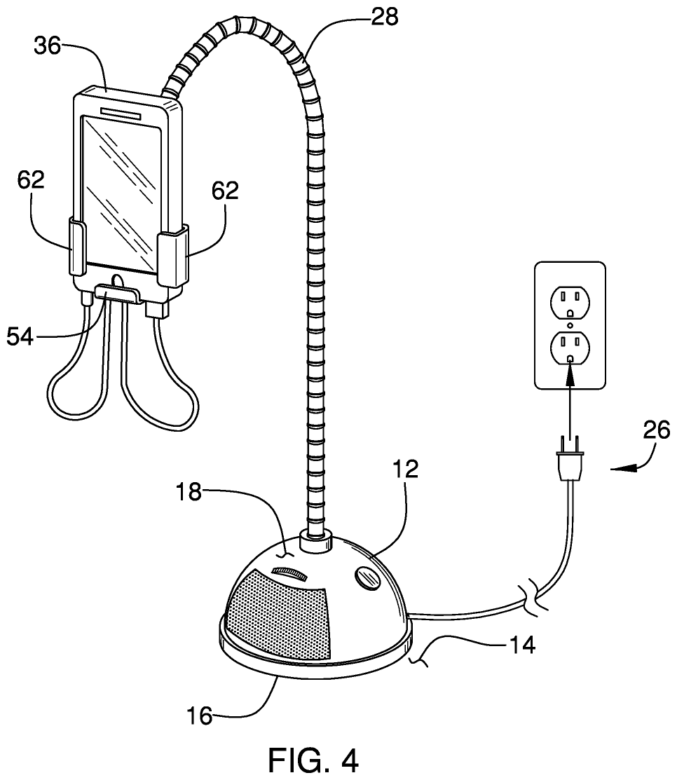

With reference now to the drawings, and in particular to FIGS. 1 through 4 thereof, a new holder device embodying the principles and concepts of an embodiment of the disclosure and generally designated by the reference numeral 10 will be described.

As best illustrated in FIGS. 1 through 4, the smart phone holder assembly 10 generally comprises a base 12 that is positionable on a horizontal support surface 14. The base 12 has a bottom surface 16 and a top surface 18 that is convexly arcuate with respect to the bottom surface 16 such that the base 12 has a dome shape. The base 12 is comprised of a weighted material having a low center of gravity such that the base 12 is inhibited from being tipped over. A speaker 20 is coupled to the base 12 to emit audible sound outwardly therefrom and the speaker 20 is positioned on the top surface 18 of the base 12.

A volume wheel 22 is rotatably coupled to the base 12 and the volume wheel 22 can be rotated by a user. The volume wheel 22 is electrically coupled to the speaker 20 and the volume wheel 22 adjusts a volume of the speaker 20 between a minimum volume and a maximum volume. The volume wheel 22 extends partially through the top surface 18 of the base 12. A power button 24 is movably coupled to the base 12 and the power button 24 is electrically coupled to the speaker 20. The power button 24 turns the speaker 20 on and off when the power button 24 is manipulated.

A power supply 26 is integrated into the base 12 and the power supply 26 is electrically coupled to the power button 24. The power supply 26 may comprise a power cord that is coupled to and extends away from the base 12. The power cord may be plugged into a power source comprising a female electrical outlet or the like. An arm 28 is coupled to and extends upwardly from the base 12. The arm 28 is comprised of a bendable material such that the arm 28 stays in whatever orientation the arm 28 is manipulated into. The arm 28 has a first end 30 and a second end 32, and the first end 30 is coupled to the top surface 18 of the base 12 at an apex of the top surface 18.

A mounting unit 34 is coupled to the arm 28 and the mounting unit 34 releasably engages a smart phone 36 to support the smart phone 36 at a selected orientation. The mounting unit 34 has a plurality of ports 38 integrated therein and each of the ports 38 is in electrical communication with a respective one of the speaker 20 and the power supply 26. Each of the ports 38 is selectively placed in electrical communication with the smart phone 36 to emit audible sound received from the smart phone 36. Moreover, the power supply 26 can charge the smart phone 36.

The mounting unit 34 comprises a panel 40 that has a front surface 42, a back surface 44 and a perimeter edge 46 extending therebetween, and the perimeter edge 46 has a bottom side 48, a first lateral side 50 and a second lateral side 52. The second end 32 of the arm 28 is coupled to the back surface 44 of the panel 40 and each of the ports 38 is integrated into the bottom side 48. The mounting unit 34 includes a support 54 that is coupled to the bottom side 48 of the perimeter edge 46. The support 54 has a leg 56 extending forwardly from the bottom side 48 and a foot 58 extending upwardly from the leg 56, and the foot 58 is spaced from the front surface 42 of the panel 40. The leg 56 supports a bottom edge 60 of the smart phone 36 and the foot 58 inhibits the smart phone 36 from sliding off of the leg 56.

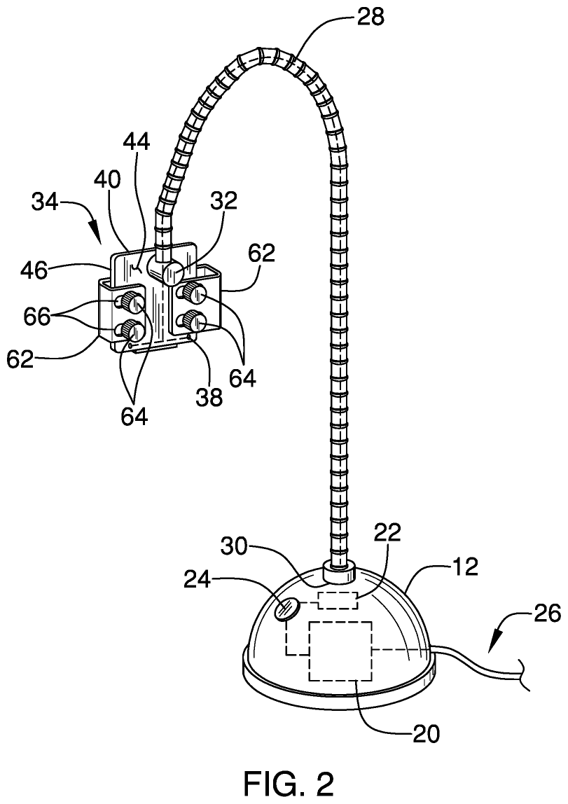

The mounting unit 34 includes a pair of clamps 62 that each extends around the front surface 42 of the panel 40 for compressing the smart phone 36 against the front surface 42 of the panel 40. A plurality of fasteners 64 is included and each of the fasteners 64 extends through a respective one of the clamps 62 and engages the back surface 44 of the panel 40. Each of the fasteners 64 is tightenable against the respective clamp 62 for retaining the clamps 62 at a desired width with respect to each other. In this way the clamps 62 can accommodate smart phones of varying widths. Each of the fasteners 64 is loosenable on the respective clamp 62 to facilitate the clamps 62 to be adjusted to a desired width. As is most clearly shown in FIG. 2, each of the clamps 62 may have a pair of elongated slots 66 extending therethrough and each of the fasteners 64 extends through a respective one of the elongated slots 66. In this way the clamps 62 can be slid laterally along the back surface 44 of the panel 40.

In use, the smart phone 36 is placed into the mounting unit 34 and the clamps 62 are positioned against the smart phone 36. Each of the fasteners 64 is tightened to retain the smart phone 36 against the panel 40. Data cables are plugged into the smart phone 36 and into respective data ports 38 on the panel 40. In this way the smart phone 36 is in electrical communication with the speaker 20 and the power supply 26. Thus, the speaker 20 can emit audible sounds from the smart phone 36 and the power supply 26 can charge the smart phone 36. Additionally, the arm 28 can be bent or twisted to position the smart phone 36 at a preferred orientation for the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A smart phone holder assembly for holding a smart phone above a support surface and facilitating auxiliary audio for the smart phone, said assembly comprising:
a base being positionable on a horizontal support surface;
a speaker being coupled to said base wherein said speaker is configured to emit audible sound outwardly therefrom;
a volume wheel being rotatably coupled to said base wherein said volume wheel is configured to be rotated by a user, said volume wheel being electrically coupled to said speaker, said volume wheel adjusting a volume of said speaker between a minimum volume and a maximum volume;
a power button being movably coupled to said base, said power button being electrically coupled to said speaker, said power button turning said speaker on and off when said power button is manipulated, said power button extending outwardly from said base and surrounded by open space adjacent to said power button;
an arm being coupled to and extending upwardly from said base, said arm being comprised of a bendable material such that said arm stays in whatever orientation said arm is manipulated into; and
a mounting unit being coupled to said arm, said mounting unit releasably engaging the smart phone wherein said mounting unit is configured to support the smart phone at a selected orientation, said mounting unit having a plurality of ports being integrated therein, each of said ports being in electrical communication with a respective one of said speaker and said power supply, each of said ports being selectively placed in electrical communication with the smart phone wherein said speaker is configured to emit audible sound received from the smart phone and said power supply is configured to charge the smart phone.

2. The assembly according to claim 1, wherein:
said base has a bottom surface and a top surface being convexly arcuate with respect to said bottom surface such that said base has a dome shape;
said speaker is positioned on said top surface of said base;
said volume wheel extends partially through said top surface of said base; and
said power button is positioned on said top surface.

3. The assembly according to claim 2, further comprising a power supply being integrated into said base, said power supply being electrically coupled to said power button.

4. The assembly according to claim 2, wherein said arm has a first end and a second end, said first end being coupled to said top surface of said base at an apex of said top surface.

5. The assembly according to claim 4, wherein said mounting unit comprises a panel having a front surface, a back surface and a perimeter edge extending therebetween, said perimeter edge having a bottom side, a first lateral side and a second lateral side, said second end of said arm being coupled to said back surface of said panel, each of said ports being integrated into said bottom side.

6. The assembly according to claim 5, wherein said mounting unit includes a support being coupled to said bottom side of said perimeter edge, said support having a leg extending forwardly from said bottom side and a foot extending upwardly from said leg, said foot being spaced from said front surface of said panel, said leg supporting a bottom edge of the smart phone, said foot inhibiting the smart phone from sliding off of said leg.

7. The assembly according to claim 5, wherein said mounting unit includes a pair of clamps, each of clamps extending around said front surface of said panel for compressing the smart phone against said front surface of said panel.

8. The assembly according to claim 7, wherein said mounting unit includes a plurality of fasteners, each of said fasteners extending through a respective one of said clamps and engaging said back surface of said panel, each of said fasteners being tightenable against said respective clamp for retaining said clamps at a desired width with respect to each other wherein said clamps are configured to accommodate smart phones of varying widths, each of said fasteners being loosenable on said respective clamp to facilitate said clamps to be adjusted to a desired width.

9. A smart phone holder assembly for holding a smart phone above a support surface and facilitating auxiliary audio for the smart phone, said assembly comprising:
a base being positionable on a horizontal support surface, said base having a bottom surface and a top surface being convexly arcuate with respect to said bottom surface such that said base has a dome shape;
a speaker being coupled to said base wherein said speaker is configured to emit audible sound outwardly therefrom, said speaker being positioned on said top surface of said base;
a volume wheel being rotatably coupled to said base wherein said volume wheel is configured to be rotated by a user, said volume wheel being electrically coupled to said speaker, said volume wheel adjusting a volume of said speaker between a minimum volume and a maximum volume, said volume wheel extending partially through said top surface of said base;
a power button being movably coupled to said base, said power button being electrically coupled to said speaker, said power button turning said speaker on and off when said power button is manipulated, said power button extending outwardly from said base and surrounded by open space adjacent to said power button;
a power supply being integrated into said base, said power supply being electrically coupled to said power button;
an arm being coupled to and extending upwardly from said base, said arm being comprised of a bendable material such that said arm stays in whatever orientation said arm is manipulated into, said arm having a first end and a second end, said first end being coupled to said top surface of said base at an apex of said top surface;
a mounting unit being coupled to said arm, said mounting unit releasably engaging the smart phone wherein said mounting unit is configured to support the smart phone at a selected orientation, said mounting unit having a plurality of ports being integrated therein, each of said ports being in electrical communication with a respective one of said speaker and said power supply, each of said ports being selectively placed in electrical communication with the smart phone wherein said speaker is configured to emit audible sound received from the smart phone and said power supply is configured to charge the smart phone, said mounting unit comprising:
a panel having a front surface, a back surface and a perimeter edge extending therebetween, said perimeter edge having a bottom side, a first lateral side and a second lateral side, said second end of said arm being coupled to said back surface of said panel, each of said ports being integrated into said bottom side;
a support being coupled to said bottom side of said perimeter edge, said support having a leg extending forwardly from said bottom side and a foot extending upwardly from said leg, said foot being spaced from said front surface of said panel, said leg supporting a bottom edge of the smart phone, said foot inhibiting the smart phone from sliding off of said leg;
a pair of clamps, each of clamps extending around said front surface of said panel for compressing the smart phone against said front surface of said panel; and
a plurality of fasteners, each of said fasteners extending through a respective one of said clamps and engaging said back surface of said panel, each of said fasteners being tightenable against said respective clamp for retaining said clamps at a desired width with respect to each other wherein said clamps are configured to accommodate smart phones of varying widths, each of said fasteners being loosenable on said respective clamp to facilitate said clamps to be adjusted to a desired width.
